(19) United States
(12) Patent Application Publication
(10) Pub. No.: US 2011/0027534 A1
(43) Pub. Date: Feb. 3, 2011

(54) MOLD RELEASE SHEET AND MOLDED ARTICLES

(76) Inventors: Masanori Ogawa, Aichi (JP); Makoto Fujii, Aichi (JP); Naohiro Mizutani, Aichi (JP)

Correspondence Address: COOPER & DUNHAM, LLP, 30 Rockefeller Plaza, 20th Floor, NEW YORK, NY, 10112, US

(21) Appl. No.: 12/922,489

(22) PCT Filed: Nov. 7, 2008
(86) PCT No.: PCT/JP2008/070299

§ 371 Date: Sep. 14, 2010

(30) Foreign Application Priority Data
Mar. 14, 2008 (JP) 2008-065918

(51) Int. Cl. B32B 29/06; B31F 1/12; D21H 13/00; B32B 27/00

(52) U.S. Cl. 428/153; 428/311.71; 428/311.11; 428/319.3; 428/172

(57) ABSTRACT

The object of the present invention is to improve the releasing property of a molded article.

To attain the object, the present invention provides a release sheet 1 characterized by coating or impregnating an aqueous binder on/in to a porous sheet, wherein the porous sheet has preferably an airflow resistance of 0.01 to 1.2 kPa·s/m, and the porous sheet is a preferably creped and/or embossed stretchable paper, the aqueous binder containing (A) a polymer produced by radical polymerization of an ethylenical unsaturated dicarboxylic anhydride or an ethylenical unsaturated dicarboxylic acid whose carboxylic acid group can form acid anhydride group, and (B) an alkanolamine having at least two hydroxyl groups.

The release sheet(s) 1 is (are) laminated onto a base material 2. When the laminated material is molded by heating, the aqueous binder quickly hardens, demonstrating its releasing property.

### FIELD OF THE INVENTION

The present invention relates to a release sheet and the molded article in which said release sheet is used, said molded article being useful for such as the interior of a car.

### BACKGROUND OF THE INVENTION

Until now, many kinds of molded articles which utilize a sheet material such as a fiber sheet into which a thermosetting resin is impregnated, or a plastic sheet, have been provided, for instance, as the material for car interiors (for example, Patent Literature 1). Said sheet material alone, or a laminated sheet in which said sheet material is attached to a base material as a surface layer, is molded by hot pressing or vacuum and/or pressure forming, to manufacture a molded article having a predetermined shape.

### Patent Literature 1: JP Patent Publication No. 3383367

### DISCLOSURE OF THE INVENTION

### Problems to be Solved by the Invention

In a case where said traditional sheet material is molded to manufacture a molded article having a predetermined shape, in the case of a fiber sheet being utilized as said sheet material, there is a problem in that the curing speed of said thermosetting resin as the binder of said fiber sheet is slow. When the curing speed of said thermosetting resin is slow, the uncured thermosetting resin may be apt to stick to the mold surface of the molding machine, and in a case where the continuous molding is conducted to achieve the mass production, the amount of matter sticking to the mold surface of said molding machine will gradually increase according to the number of times a shot is to be made. As a result, said sticking matter acts as adhesive, sticking said fiber sheet to the mold surface, deteriorating the releasing property of said molded article from the mold surface of the molding machine. In a case where a plastic material is utilized as sad sheet material, the sheet surface may melt and stick to said mold surface, deteriorating the molded article's releasing property from the mold. As a result of deterioration of the releasing property of said molded article from the mold surface, the problem that the surface of said molded article may be rough when released from said mold arises.

Regarding the problem of the deterioration of the releasing property of said molded article from said mold surface, said problem may be temporarily solved by applying a release agent to the mold surface after each mold shot during the molding operation. In the case of mass-production, however, the molding operation must be stopped in order to apply said release agent to the mold surface after each mold shot, resulting in the deterioration of workability and depreciation in production quantities. Further, the spraying of said release agent causes environment deterioration around the work site, and further in a case where said sprayed release agent adheres to the surface of said sheet material or the surface of said molded articles, there arises a problem in that the performance and quality which are expected from said molded article are degraded.

### Means to Solve Said Problems

As means to solve said problems, the present invention provides a release sheet 1 wherein an aqueous binder containing (A) a polymer produced by radical polymerization of an ethylenical unsaturated dicarboxylic anhydride, or an ethylnical unsaturated dicarboxylic acid whose carboxylic acid group can form an acid anhydride group, and (B) an alkanolamine having at least two hydroxyl groups, is coated or impregnated on/in to a porous sheet.

Said porous sheet preferably has an airflow resistance in the range of between 0.01˜1.2 kPa·s/m.

Generally, said porous sheet is a fiber sheet or paper, said paper preferably being a stretchable paper which is creped and/or embossed.

In the present invention, a molded article which is made by attaching said release sheet(s) 1 to one or both sides of a base material 2, and then molding it into a predetermined shape, is provided.

### EFFECT OF THE INVENTION

### Action

Said aqueous binder which is coated or impregnated on/in to said release sheet 1 contains a acid anhydride and an alkanolamine as a cross-linking agent, and said acid anhydride quickly reacts with said alkanolamine. Accordingly, when said release paper is molded by hot forming such as hot pressing or vacuum forming, said aqueous binder quickly hardens, so that the sticking of said aqueous binder to the mold surface of the molding machine is suppressed, preventing the deterioration of the releasing property of the resulting molded article from the molding machine

In a case where a porous sheet, which is used as the base sheet of said release sheet 1, has an airflow resistance in the range of between 0.01 and 1.2 kPa·s/m, the exudation of the impregnated material or mixture contained in said base material 2 to the surface of said release sheet 1 is suppressed, so that the deterioration of the releasing property of the resulting molded article by said material or mixture exuding to the surface of said release sheet 1 is prevented. In a case where the porous sheet as the base sheet of said release sheet 1 is a stretchable paper which is creped or embossed, when said release sheet 1 is attached to said base material 2 so as to mold them into a predetermined shape, the exudation of said impregnated material, or the mixture contained in said base material 2 to the surface of said release sheet 1 is suppressed, so that the deterioration of the releasing property of the resulting molded article by said material or mixture exuding to the surface of said release sheet 1 is prevented, and further defective molding is prevented by stretching said stretchable paper during molding.

### [Effect]

Accordingly, in the present invention, in a case where a base material 2 is molded, since the adhesion of the resin to the mold surface is prevented by said release sheet(s) 1 which is (are) attached to one or both sides of said base material 2, the releasing property of the resulting molded article 7 is much improved, and further the cost and time required to repeatedly apply the releasing agent to the mold surface of the molding machine and rewash the mold surface again and again, are saved.

### BRIEF DESCRIPTION OF THE DRAWINGS

FIG. 1: An illustration of the height h of the projection.

FIG. 2: An illustration of the principle of the measurement of airflow resistance.

FIG. 3: A cross sectional view of the laminated material.

FIG. 4: An illustration of the molding process.

FIG. 5: A cross sectional view of the molded article.

### EXPLANATION OF NUMBERS IN DRAWINGS

1: Release sheet
2. Base material
3. Laminated material
4. Upper mold part
5. Lower mold part
6. Press molding machine
7. Molded article

### BEST MODE TO PRACTICE THE INVENTION

The present invention is precisely described below.

### [Release Sheet]

The release sheet used in the present invention comprises a base sheet and an aqueous binder coated or impregnated on/in to said base sheet as a core material.

As said base sheet, a porous sheet into which said aqueous binder can be impregnated is used. As said porous sheet, a fiber sheet consisting of fibers, or a paper sheet consisting of a paper material may be illustrated.

### [Fiber Sheet]

The fiber used as the material of said fiber sheet is such as a synthetic fiber, such as polyester fiber, polyamide fiber, polypropylene fiber, acrylic fiber, urethane fiber, polyvinyl chloride fiber, polyvinylidene chloride fiber, acetate fiber, or the like, a natural fiber such as wool, mohair, cashmere, camel hair, alpaca, vicuna, angora, silk, raw cotton, cattail fiber, pulp, cotton, palm fiber, hemp fiber, bamboo fiber, kenaf fiber, or the like, a biodegradable fiber such as starch group, polylactic acid group, or the like, a cellulose group artificial fiber such as rayon fiber (artificial silk, viscose staple fiber), polynosic fiber, cuprammonium rayon fiber, acetate fiber, triacetate fiber, or the like, an inorganic fiber such as glass fiber, carbon fiber, ceramic fiber, asbestos fiber, or the like, and a reclaimed fiber obtained by the opening of a scrap fiber product made of said fiber(s). Said fiber can be used singly, or two or more kinds of said fiber can be used together in the present invention.

In the present invention, a fiber having a melting point of below 180° C. may be used partially or wholly as said fiber material for said fiber sheet.

Said low melting point fiber may be such as a fiber having a melting point of below 180° C., such as a polyolefin group fiber such as polyethylene, polypropylene, ethylene-vinyl acetate copolymer, ethylene-ethyl acrylate copolymer, or the like, polyvinyl chloride fiber, polyurethane fiber, polyester fiber, copolymerized polyester fiber, polyamide fiber, copolymerized polyamide fiber, or the like. Said low melting point fiber may be used singly, or two or more kinds of said fiber having a low melting point may be used together, or two or more kinds of fiber selected from the aforementioned standard melting point fiber, and said low melting point fiber may be used together. The fineness of said fiber having a low melting point is preferably in the range of between 0.1 and 60 dtex. Usually said low melting point fiber may be mixed in with the aforementioned standard melting point fiber in the range of between 1 and 50% by mass.

Said fiber sheet is manufactured by various methods such as the method wherein a sheet or mat of said fiber web is needle-punched so as to entangle the fibers in said sheet or mat together, or the method wherein, in a case where said sheet or mat of said fiber web consists of low melting point, or said low melting point fiber is mixed into said web, said web as it is or said web is needle-punched to entangle said fibers, following which said sheet or mat is heated so as to soften said low melting point fibers and bind said fibers together by melting, or the thermal bond method wherein low melting point fibers are attached by pressing with a heat roll, or the spunbond method wherein the obtained web is heat-welded with a heat roll when the fibers are melt spun, being piled up on a movement collection plate, the melt blown method, stitch bond method, spunlace method, or the method wherein a synthetic resin binder is impregnated into or mixed in with said fiber web so as to bind said fibers together with said synthetic resin binder, or the method wherein said sheet of said fiber web is needle punched so as to entangle said fibers in said sheet together, following which a synthetic resin powder, solution, emulsion, or latex is mixed in, impregnated into, or coated onto the resulting needle punched sheet, so as to bind said fibers, or the method wherein said fibers are knitted or woven, or the like.

Commonly the unit weight of said fiber sheet is between 10 and 200 g/m², with a thickness of between 0.1 and 5.0 mm.

### [Paper Sheet]

As said paper material used in said paper sheet, wood pulp such as mechanical pulp, chemical and mechanical pulp, semi-chemical pulp, or the like, may be used, and if desired, sediment pulp, waste paper pulp, cotton, linseed, lamy, abaca, jute pulp, kenaf, straw, esparto, bagasse, bamboo, kouzo (Broussonetia kazinoki×B. papyrifera), oriental paperbush, ganpi (Diplomorpha sikokiana), nylon, tetoron (polyester fiber), cashmilon (polyacrylonitrile fiber), vonnel (polyacrylic fiber), or the like can be added; normal paper, which usually includes the aforementioned materials, may also be used.

As a paper sheet suitable for said base sheet, stretchable paper materials are listed. As said stretchable paper materials, a creped paper having a large number of wrinkles on its surface, an embossed paper having a large number of projections on its surface, or a creped and embossed paper having both a large number of crepes and projections on its surface, are illustrated.

By using said creped and/or embossed paper having a large number of wrinkles or projections on its surface a release sheet having good moldability is obtained. Moreover said creped and/or embossed paper has an excellent sound absorbing performance, so that said creped and/or embossed paper is suitable for the base sheet of said release sheet, particularly in a case where said molded article in which said release sheet is used, is in the interior of a car.

Said creped paper is manufactured by processing crepes on a green paper. Said crepe processing includes the wet creping process, wherein a wet paper is compressed longitudinally (in the papering direction) with a press roll, doctor blade, or the like, for wrinkling, and the dry creping process, wherein said green paper is dried with a Yankee drier or calender, after which the resulting dried green paper is then compressed longitudinally with a doctor blade or the like, for wrinkling. For instance, the degree of creping of said stretchable paper, which is the creped paper, is preferably in the range of between 10 and 50%.

Herein said degree of creping is defined by the following formula.

Degree of creping(%)=(A/B)×100

wherein A is the speed of papering in the papering process, and B is the rolling speed of the paper.

In other words, said degree of creping is the longitudinal (in the papering direction) degree of compression of said green paper (paper web).

In a case where the degree of creping is below 10%, the stretchability of said creped paper will become inadequate, so that said creped paper having a degree of creping below 10% is apt to wrinkle during molding. On the other hand, said creped paper having a degree of creping over 50% is also apt to wrinkle during molding. Furthermore, in a case where the degree of creping is below 10%, the sound absorbing performance of said creped paper will decline.

Said embossed paper is manufactured by pressing an embossing roll or plate having an uneven surface, which is formed by carving or etching (embossing roll, embossing plate), onto said green paper, to form a number of projections on the surface of said green paper, the height of said projections, preferably being in the range of between 0.02 and 2.00 mm, and the number of said projections preferably being in the range of between 20 and 200 projections/cm². In a case where the height of said projections is below 0.02 mm, the stretchability of said embossed paper will become inadequate, so that said embossed paper having projections with a height of below 0.02 mm is apt to wrinkle during molding. On the other hand, said embossed paper having projections with a height of over beyond 2.00 mm is also apt to wrinkle during molding. In a case where the number of projections is below 20 projections/cm², the stretchability of said embossed paper will become inadequate, so that said embossed paper in which the number of projections is below 20 projections/cm², is apt to wrinkle during molding and its sound absorbing performance will decline. On the other hand, in a case where the number of projections is over 200 projections/cm², the sound absorbing performance of said embossed paper will decline. In FIG. 1, a number of projections 2 are formed on the surface of said embossed paper 1a (stretchable paper), with the height of said projections being expressed as “h” in FIG. 1.

Further, in the embossing process, said creped paper is used as said green paper, to obtain said embossed and creped paper.

The unit weight of said paper sheet is usually set to be 5˜50 g/m², with a thickness being usually set to be 0.1˜0.5 mm; its airflow resistance is preferably set to be 0.01˜1.2 kPa·s/m.

### [Airflow Resistance of Porous Sheet]

Said porous sheet such as said fiber sheet or paper sheet preferably has an airflow resistance in the range of between 0.01 and 1.2 kPa·s/m, in the case where said porous sheet is used as the base sheet of said release sheet.

In a case where the airflow resistance of said base sheet is below 0.01 kPa·s/m, the impregnated material or the mixture impregnated into or mixed in with said base material may exude to the surface of said release sheet, deteriorating its releasing property, and further, said release sheet is apt to be torn during molding, so that a release sheet having good moldability cannot be obtained.

On the other hand, in a case where the airflow resistance of said base sheet is over 1.2 kPa·s/m, the exudation of the impregnated material or mixture can be suppressed, but the resulting base sheet will have poor stretchability, so that wrinkles may be formed in said release sheet during molding. Further, in a case where said porous sheet having an airflow resistance out of the range between 0.01 and 1.2 kPa·s/m is used as said base sheet, the resulting release sheet will have poor sound absorbing performance, so that said release sheet will not be suitable to use in the molded article to be used for the car interior which requires to have a good sound absorbing performance.

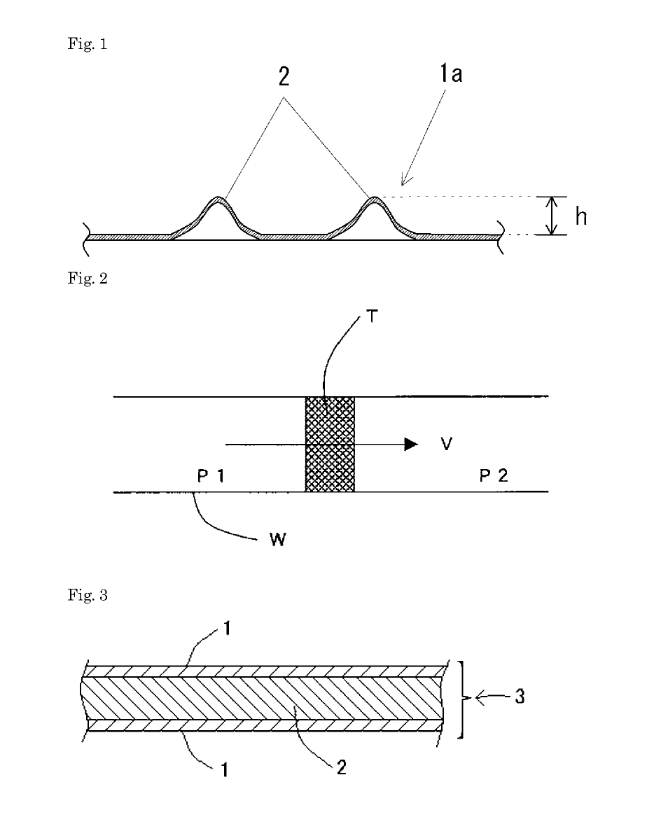

Said airflow resistance R (Pa·s/m) is a barometer expressing the degree of airflow of air permeable material. To measure said airflow resistance R, the steady flow differential-pressure measuring method is applied. As shown in FIG. 2, a test piece T is arranged in a cylindrical duct W, and air is put into said duct at a constant flow V as shown by the arrow, to measure the difference in pressure in said duct between inlet side P1, and outlet side P2. The airflow resistance is calculated using the following formula.

R=ΔP/V

Herein ΔP is the difference in pressure Pa(ΔP═P1−P2), and V represents the volume of air flow for said unit cross section area of said duct (m³/m²·S).

Said airflow resistance R(Pa·s/m) has the following relation to the degree of airflow C(m/Pa·s). C=1/R

Said airflow resistance can be measured with such as the airflow tester (Trade Name: KES-F8-AP1, KATO TECH CO., LTD. The steady flow differential pressure measuring method).

### [Aqueous Binder]

An aqueous binder is impregnated into the base sheet of said release sheet. Said aqueous binder contains a polymer (A) containing 5 to 100% by mass, preferably 5 to 50% by mass, and most preferably 10 to 40% by mass of an ethylenical unsaturated dicarbonic acid anhydride or an ethylenical unsaturated dicarboxylic acid whose carboxylic acid group can form acid anhydride (hereafter to be described as monomer (a)).

The preferable ethylenical unsaturated acid anhydride is an ethylenical unsaturated dicarboxylic acid anhydride. The preferable ethylenical unsaturated dicarboxylic acid is generally a dicarboxylic acid having a pair of carboxylic acid groups bond to adjoining carbons.

Said carboxylic acid group may be of salt type. A preferable monomer (a) is maleic acid, maleic anhydride, itaconic acid, 1,2,3,6-tetrahydrophthalic acid, 1,2,3,6-tetrahydrophthalic anhydride, or their alkali metal, and ammonium salts, or mixtures.

Maleic acid and maleic anhydride are especially preferable monomers(a).

Besides said monomer (a), said polymer (A) may contain a further monomer (b).

As a preferable monomer(b), the monomers described below, for instance, groups (1) to (8) are used.

(1) Monoethylenically unsaturated C₃˜C₁₀-monocarboxylic acids, (monomer b₁), for example, acrylic acid, methacrylic acid, ethylacrylic acid, allylacetic acid, crotonic acid, vinylacetic acid, maleic monoesters such as methyl hydrogen maleate, their mixtures and their alkali metal and ammonium salts.

(2) Linear 1-olefins, branched-chain 1-olefins, or circled olefins (monomer b₂), for example, ethene, propene, butene, isobutene, pentene, cyclopentene, hexene, cyclohexene, octene, 2,4,4-trimethyl-1-pentene with or without 2,4,4-trimethyl-2-penten, C₈˜C₁₀-olefin, 1-dodecene, C₁₂˜C₁₄-olefin, octadecene, 1-eicosene(C₂₀), C₂₀˜C₂₄-olefin; metallocene-catalytically prepared oligoolefins having a terminal double bond, for example, oligopropene, oligohexene, and oligooctadecene; cationically polymerized olefins having a high α-olefin content for example, polyisobutene.

(3) Vinyl and allyl alkyl ethers having from 1 to 40 carbon atoms in the alkyl radical, which alkyl radical can carry further substituents such as hydroxyl, amino or dialkylamino or one or more alkoxylate groups (monomer b₃), for example, methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-n-butylamino)ethyl vinyl ether, methyldiglycol vinyl ether and also the corresponding allyl ethers and mixtures thereof.

(4) Acrylamides and alkyl-substituted acrylamides (monomer b₄), for example, acrylamide methacrylamide, N-tert-butylacrylamide, N-methyl(meth)acrylamide.

(5) Sulfo-containing monomers (monomer b₅), for example, allylsulfonic acid, methallylsulfonic acid, styrene sulfonate, vinylsulfonic acid, allyloxybenzensulfonic acid, 2-acrylamide-2-methylpropanesulfonic acid and their corresponding alkali metal or ammonium salts or mixtures thereof.

(6) C₁˜C₈-alkyl or C₁˜C₄-hydroxyalkyl esters of acrylic acid, methacrylic acid, or acrylic, methacrylic or maleic esters of C₁˜C₁₈-alcohols alkoxylated with from 2 to 50 mol of ethylene oxide, propylene oxide, butylene oxide or mixtures thereof (monomer b₆), for example, methyl (meth)acrylate, ethyl (meth)acrylate, isopropyl (meth)acrylate, butyl (meth)acrylate, hexyl (meth)acrylate, 2-ethylhexyl (meth)acrylate, hydroxyethyl (meth)acrylate, hydroxypropyl (meth)acrylate, 1,4-butanediol monoacrylate, dibutyl maleate, ethyldiglycol acrylate, methylpolyglycol acrylate (11EO), (meth)acrylic esters of C₁₃/C₁₅-oxo alcohol reacted with 3,5,7,10, or 30 mol of ethylene oxide, or mixtures thereof.

(7) Alkylaminoalkyl (meth)acrylates or alkylaminoalkyl (meth)acrylamides, or quaternization products thereof (monomer b₇), for example, 2-(N,N-dimethylamino)ethyl (meth)acrylate, 3-(N,N-dimethylamino)propyl (meth)acrylate, 2-(N,N,N-trimethylammonio) ethyl (meth)acrylate chloride, 2-dimethylaminoethyl (meth)acrylamide, 3-dimethylaminopropyl (meth)acrylamide, 3-trimethylammoniopropyl (meth)acrylate chloride.

(8) Vinyl and allyl esters of C₁˜C₃₀-monocarboxylic acids (monomer b₈), for example, vinyl formate, vinyl acetate, vinyl propionate, vinyl butylate, methyl pentanoate, vinyl 2-ethylhexanoate, vinyl nonanoate, vinyl decanoate, vinyl pivalate, vinyl palmitate, vinyl stearate, vinyl laurate.

Further, monomers b₉ are illustrated below.

N-vinylfolmamide, N-vinyl-N-methylfolmamide, styrene, α-methylstyrene, 3-methylstyrene, butadiene, N-vinylpyrrolidone, N-vinylimidazole, 1-vinyl-2-methylimidazole, 1-vinyl-2-methylimidazoline, N-vinylcaprolactam, acrylonitrile, methacrylonitrile, allylalcohol, 2-vinylpyridine, 4-vinylpyridine, diallyldimethylammonium chloride, vinylidene chloride, vinyl chloride, acrolein, methacrolein, vinylcarbazole and mixtures thereof.

As well as monomer (a), the polymer can additionally contain from 0 to 95% by weight of monomer (b). Preferably, as well as monomer (a), the polymer additionally contains monomer (b) in amounts from 50 to 95% by mass, particularly preferably from 60 to 90% by mass.

Preferred monomers (b) are acrylic acid, methacrylic acid, ethene, propene, butene, isobutene, cyclopentene, methyl vinyl ether, ethyl vinyl ether, acrylamide, 2-acrylamide-2-methylpropanesulfonic acid, vinyl acetate, styrene, butadiene, acrylonitrile, and mixtures thereof.

A particularly preferable monomer (b) is such as acrylic acid, methacrylic acid, ethene, acrylamide, styrene, and acrylonitrile and mixtures thereof. In particular, acrylic acid, methacrylic acid, acrylamide and mixtures thereof are preferable.

Said polymer (A) can be produced by a common process such as block polymerization, emulsion polymerization, suspension polymerization, dispersion polymerization, precipitation polymerization, or solution polymerization.

To prepare said aqueous binder of the present invention, an alkanol amine (B) having at least two hydroxyl groups (OH group) is added to said polymer (A).

Said alkanol amine (B) preferably has the following formula (1)

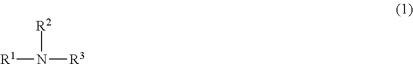

Herein R¹ represents hydrogen atom, C₁˜C₁₀-alkyl group, or C₁˜C₁₀-hydroxyalkyl group, and R², R³ represents C₁˜C₁₀-hydroxyalkyl group.

Preferably, R² and R³ independently represent C₂˜C₅-hydroxyalkyl group and R¹ represents the hydrogen atom, C₁˜C₅-alkyl group or C₂˜C₅-hydroxyalkyl group.

As a compound having the formula (1), for instance, diethanolamine, triethanolamine, diisopropanolamine, triisopropanolamine, methyldiethanolamine, butyldiethanolamine, and methyldiisopropanolamine are illustrated. Triethanolamine is a more preferable alkanolamine (B).

To prepare said aqueous binder of the present invention, said polymer (A) and said alkanolamine (B) are used together so that the mole ratio of carboxyl group of said polymer (A) and hydroxyl group of said alkanolamine (B) is set to be 20:1 to 1:1, preferably 8:1˜5:1, and most preferably 5:1 to 1.7:1, (in this case the acid anhydride group is regarded a group having two carboxyl groups).

Said aqueous binder of the present invention is produced simply by adding said aklanolamine (B) to an aqueous dispersion or solution of said polymer (A).

Said aqueous binder contains a reaction promoter containing phosphorous in an amount of preferably below 0.1% by mass, more preferably of below 0.5% by mass, still more preferably of below 0.3% by mass, and especially below 0.1% by mass for the sum A+B. Said reaction promoter containing phosphorous is described in U.S. Pat. No. 651,088 and U.S. Pat. No. 583,086, and said reaction promoter containing phosphorous is alkali metal hypophosphite, -phosphite, polyphosphate, dihydrogen phosphate, polyphosphoric acid, hypophosphorous acid, phosphoric acid, alkylphosphinic acid, or salts, oligomers, or polymers thereof.

Said aqueous binders are marketed under the trade names, Acrodur L, Acrodur D (Trade name: BASF JAPAN Ltd.).

Said aqueous binder is described precisely in Tokuhyo 2000-506940.

### [Manufacturing of the Release Sheet]

Said release sheet of the present invention is manufactured by coating or impregnating said aqueous binder on/in to said base sheet. To coat or impregnate said aqueous binder on/in to said base sheet, well known methods such as spray coating, roll coating, knife coating, curtain flow coating, dipping, or the like is applied.

In a case where said aqueous binder is coated or impregnated on/in to said base sheet, the coating or impregnating amount of said aqueous binder is commonly set to be 1 to 40% by mass as a solid, for the weight of said base sheet. In a case where said coating or impregnating amount is below 1% by mass, the resulting release sheet will have an insufficient releasing property, and in a case where said coating or impregnating amount is over 40% by mass, an excess of said aqueous binder is coated or impregnated on/in to said base sheet, and as a result, the flexibility of said base sheet will be degraded, and the problem of increasing cost may occur. In order to control the impregnating amount in said base sheet, after said aqueous binder has been coated or impregnated on/in to said base sheet, for instance, said base sheet on/in to which said aqueous binder has been coated or impregnated is squeezed out with a squeezing roll.

After said aqueous binder is coated or impregnated on/in said base sheet, the resulting base sheet on/in to which said aqueous binder has been coated or impregnated is then dried at room temperature, or preferably by heating at a temperature commonly in the range of between 100° C. and 200° C., for one to five minutes. During said heat drying process, the gel fraction (%) of said aqueous binder impregnated into said base sheet will be changed in the range of between 0.5% and 100%, but any release paper containing said aqueous binder having a gel fraction in the range of between 0.5% and 100% is usable, so that the gel fraction of said aqueous binder has no relation to the properties of said release sheet of the present invention.

### [Molded Article]

Said molded article is manufactured by attaching said release sheet(s) onto one or both sides of said base material 2, and then molding said base material one or both sides of which said release sheet(s) is (are) attached into a predetermined shape. Additionally, said release sheet 1 can be used as a surface material for said molded article, and can also be simply used to improve the releasing property of said base material 2 from the molding machine. Accordingly, in a case where said release sheet 1 is used to improve said releasing property, said release sheet 1 may be set to be peeled from said base material 2, when or after the resulting molded article is released or pulled out of its mold.

As said base material 2, thermoplastic resin such as ionomer resin, ethylene-ethyl acrylate (EEA) resin, copolymerized acrylonitrile-styrene-acrylic rubber (ASA) resin, copolymerized acrylonitrile-styrene (AS) resin, copolymerized acrylonitrile-chlorinated polyethylene-styrene (ACS) resin, copolymerized ethylene-vinyl acetate (EVA) resin, copolymerized ethylene-vinyl alcohol (EVOH) resin, polymethylmethacrylate resin (PMMA), polybutadiene (BDR), polystyrene (PS), polyethylene (PE), copolymerized acrylonitrile-butadiene-styrene (ABS) resin, chlorinated polyethylene (CPE), polyvinyl chloride (PVC), polyvinylidene chloride (PVDC), polypropylene (PP), cellulose acetate (CA) resin, syndiotactic polystyrene (SPS), polyoxymethylene (=polyacetal) (POM), polyamide (PA), polyimide (PI), polyamide imide (PAI) polyether imide (PEI), polyarylate (PAR), thermoplastic polyurethane (TPU) elastomer, thermoplastic elastomer (TPE), liquid crystal polymer (LCP), polyether ether ketone (PEEK), polysulfone (PSF), polyether sulfone (PES), fluorocarbon polymer, polytetrafluoroethylene (PTFE), polyethylene terephthalate (PET), polycarbonate (PC), polyphenylene ether (PPE), modified PPE, polyphenylene sulfide (PPS), polybutylene terephthalate (PBT), polybenzimidazole (PBI), wholly aromatic polyester (POB), or the like, thermosetting resin such as urethane resin, melamine resin, thermosetting acrylic resin, urea resin, phenol resin, epoxy resin, thermosetting polyester, or the like, may be used.

As said base material 2, an air-permeable formed material or sintered material of said thermoplastic resin, and said thermosetting resin may be used. As said air-permeable formed material and sintered material, a foamed resin such as foamed polyurethane, foamed polyethylene, foamed polypropylene, foamed polystyrene, foamed polyvinyl chloride, foamed epoxy resin, foamed melamine resin, foamed urea resin, foamed phenol resin, or the like, and sintered plastic bead, or the like, may be used.

The unit weight of said air permeable foamed material or sintered material is commonly set to be in the range of between 50 and 1000 g/m², with the thickness of said air permeable foamed material or sintered material being commonly set to be in the range of between 5 and 50 mm.

Additionally, a fiber material made of the same fiber as used in said fiber sheet, as said base sheet of said release sheet, may be used as said base material 2.

Further, in a case where said base material 2 is made of a porous material such as said air permeable material or fiber material, if desired, a synthetic resin may be impregnated into said porous material or a synthetic resin may be also impregnated into the porous sheet as said base sheet of said release sheet. As said synthetic resin, a thermoplastic resin and/or a thermosetting resin is (are) used.

As a material to be impregnated into said porous material or said porous sheet, a solution or powder of thermosetting resin precondensation product such as phenol resin precondensation product, urea resin precondensation product, melamine resin precondensation product, or the like, a solution or emulsion of acrylic group resin, styrene group resin, styrene-butadiene group resin, styrene-acrylonitrile-butadiene group resin, vinyl acetate group resin, olefin group resin, epoxy group resin, or the like, a flame retardant such as ammonium phosphate, organophosphate, a tetrachlorophthalic acid, tetrabromobisphenol A, or the like, a plasticizer, antioxidant, ultraviolet absorber, lubricant, and strengthening agent, are illustrated, and as a mixture, for instance, the powder of said thermosetting resin precondensation product, a powdered hot melt resin, the powder of a flame retardant such as ammonium polyphosphate, antimony trioxide, paraffin chloride, expandable graphite, or the like, a thermal expansion powder, antioxidant powder, ultraviolet absorber powder, lubricant powder, pigment, or the like are illustrated.

As said thermoplastic resin, thermoplastic acrylic resin, ethylene-vinyl acetate (EVA) resin, vinyl acetate resin, styrene resin, polybutadiene (BDR), polyisoprene, polychloroprene, chlorinated polyethylene (CPE), cellulose acetate (CA), cellulose acetate butylate (CAB), thermoplastic polyurethane elastomer, thermoplastic styrene group elastomer, or the like are illustrated, and as said thermosetting resin, for instance, urethane resin, melamine resin, thermosetting acrylic resin, in particular, a thermosetting acrylic resin which is formed into an ester bond and stiffened by heating, a urea resin, phenol resin, epoxy resin, thermosetting polyester, or the like, and further, a synthetic resin precursor utilized to produce said synthetic resin may be also used. Said synthetic resin precursor may include such as a prepolymer, oligomer, and monomer such as urethane resin prepolymer, urea resin prepolymer (precondensation polymer), phenol group resin prepolymer (precondensation polymer), diallyl phthalate prepolymer, acrylic oligomer, polyatomic isocyanate, methacrylic ester monomer, diallyl phthalate monomer, or the like. For easy handling, said thermoplastic resin or said thermosetting resin is preferably provided as an aqueous solution, aqueous emulsion, or aqueous dispersion, and may also be provided as an organic solvent solution.

The addition of said thermoplastic resin and/or thermosetting resin is to improve dimensional and shape stability, and rigidity.

A phenol group resin is an especially preferable synthetic resin in the present invention.

Said phenol group resin is produced by the condensation of a phenol group compound, and formaldehyde and/or a formaldehyde donor.

### (Phenol Group Compound)

The phenol group compound used to produce said phenol group resin may be a monohydric phenol, or polyhydric phenol, or a mixture of monohydric phenol and polyhydric phenol, but in a case where only a monohydric phenol is used, formaldehyde is apt to be emitted when or after said resin composition is cured, making polyphenol or a mixture of monophenol and polyphenol most desirable.

### (Monohydric Phenol)

The monohydric phenols include an alkyl phenol such as o-cresol, m-cresol, p-cresol, ethylphenol, isopropylphenol, xylenol, 3,5-xylenol, butylphenol, t-butylphenol, nonylphenol or the like; a monohydric derivative such as o-fluorophenol, m-fluorophenol, p-fluorophenol, o-chlorophenol, m-chlorophenol, p-chlorophenol, o-bromophenol, m-bromophenol, p-bromophenol, o-iodophenol, m-iodophenol, p-iodophenol, o-aminophenol, m-aminophenol, p-aminophenol, o-nitrophenol, m-nitrophenol, p-nitrophenol, 2,4-dinitrophenol, 2,4,6-trinitrophenol or the like; a monohydric phenol of a polycyclic aromatic compound such as naphthol or the like. Each monohydric phenol can be used singly, or as a mixture thereof.

### (Polyhydric Phenol)

The polyhydric phenols mentioned above include resorcin, alkylresorcin, pyrogallol, catechol, alkyl catechol, hydroquinone, alkyl hydroquinone, phloroglucinol, bisphenol, dihydroxynaphthalene or the like. Each polyhydric phenol can be used singly, or as a mixture thereof. Resorcin and alkylresorcin are more suitable than other polyhydric phenols. Alkylresorcin, in particular, is the most suitable of polyhydric phenols because alkylresorcin can react with aldehydes more rapidly than resorcin.

The alkylresorcins include 5-methyl resorcin, 5-ethyl resorcin, 5-propyl resorcin, 5-n-butyl resorcin, 4,5-dimethyl resorcin, 2,5-dimethyl resorcin, 4,5-diethyl resorcin, 2,5-diethyl resorcin, 4,5-dipropyl resorcin, 2,5-dipropyl resorcin, 4-methyl-5-ethyl resorcin, 2-methyl-5-ethyl resorcin, 2-methyl-5-propyl resorcin, 2,4,5-trimethyl resorcin, 2,4,5-triethyl resorcin, or the like.

A polyhydric phenol mixture produced by the dry distillation of oil shale, which is produced in Estonia, is inexpensive, and includes 5-methyl resorcin, along with many other kinds of alkylresorcin which is highly reactive, so that said polyhydric phenol mixture is an especially desirable raw polyphenol material for the present invention.

Further, among said polyhydric phenols, one or a mixture of two or more kinds of resorcin group compound such as resorcin, alkylresorcin or the like (including a polyhydric phenol mixture produced by the dry distillation of oil shale which is produced in Estonia), and a resorcin group resin consisting of aldehyde and/or an aldehyde donor, are desirable for use as a phenol group resin in the present invention.

### [Formaldehyde Donor]

In the present invention, said phenol group compound and formaldehyde and/or formaldehyde donor are condensed together. Said formaldehyde donor refers to a compound or mixture thereof which emits aldehyde when said compound or mixture decomposes. Said aldehyde donor is such as paraformaldehyde, trioxane, hexamethylenetetramine, tetraoxymethylene, or the like. In the present invention, a formaldehyde and formaldehyde donor are combined together, hereafter to be described as a formaldehyde group compound.

### [Production of Phenol Group Resin]

There are two types of said phenol group resin, one is a resol type, which is produced by the reaction between said phenol group compound and an excess amount of said formaldehyde group compound, using an alkali as a catalyst, and the other novolak type is produced by the reaction between an excess amount of said phenol group compound and formaldehyde group compound, using an acid as a catalyst. Said resol type phenol group resin consists of various phenol alcohols produced by the addition of formaldehyde to phenol, and is commonly provided as a water solution, while said novolak phenol group resin consists of various dihydroxydiphenylmethane group derivatives, wherein said phenol group compounds are further condensed with phenol alcohols, said novolak type phenol group resin being commonly provided as a powder.

As for the use of said phenol group resin in the present invention, said phenol group compound is first condensed with a formaldehyde group compound to produce a precondensate, after which the resulting precondensate is applied to said fiber sheet, thus being followed by resinification with a curing agent, and/or by heating.

To produce said condensate, a monohydric phenol may be condensed with a formaldehyde group compound to produce a homoprecondensate, or a mixture of monohydric phenol and polyhydric phenol may be condensed with a formaldehyde group compound to produce a coprecondensate of monohydric phenol and polyhydric phenol. To produce said coprecondensate, either of said monohydric phenol or polyhydric phenol may be previously condensed with said formaldehyde group compound to produce a precondensate, or both monohydric phenol and polyhydric phenol may be condensed together.

In the present invention, the desirable phenol group resin is a phenol-alkylresorcin cocondensation polymer. Said phenol-alkylresorcin cocondensation polymer provides a water solution of said cocondensation polymer(pre-cocondensation polymer) having good stability, and being advantageous in that it can be stored for a longer time at room temperature, as compared with a condensate consisting of only a phenol (precondensation polymer). Further, in a case where said sheet material is impregnated or coated with said water solution, and then precured, said fiber sheet has good stability and does not lose its moldability after longtime storage. Further, since alkylresorcin is highly reactive to a formaldehyde group compound, and catches free aldehydes to react with, the content of free aldehydes in said resin can be reduced.

The desirable method for producing said phenol-alkylresorcin cocondensation polymer is first to create a reaction between phenol and a formaldehyde group compound to produce a phenol group resin precondensate, and then to add alkylresorcin, and if desired, a formaldehyde group compound, to said phenol group resin precondensate, to create a reaction.

In the case of method (a), for the condensation of a monohydric phenol and/or polyhydric phenol, and a formaldehyde group compound, 0.2 to 3 moles of said formaldehyde group compound is added to 1 mole of said monohydric phenol; 0.1 to 0.8 mole of said formaldehyde group compound is added to 1 mole of said polyhydric phenol, as usual. If necessary, additives may be added to the phenol resins (precondensation polymers). In said method(s), there is a condensation reaction caused by applying heat to 55 to 100° C. for 8 to 20 hours. The addition of said formaldehyde group compound may be made at once at the beginning of the reaction, or several separate times throughout the reaction, or said formaldehyde group compound may be dropped in continuously throughout said reaction.

Further, if desired, the phenol group compounds and/or precondensates thereof may be copolycondensed with amino resin monomers such as urea, thiourea, melamine, thiomelamine, dicyandiamine, guanidine, guanamine, acetoguanamine, benzoguanamine, 2,6-diamino-1,3-diamine, and/or with the precondensation polymers of said amino resin monomers, thus producing said phenol group resins.

To produce said phenol group resin, a catalyst or pH control agent may be mixed in, if needed, before, during or after the reaction. Said catalyst or pH control agent is, for example, an organic or inorganic acid such as hydrochloric acid, sulfuric acid, orthophosphoric acid, boric acid, oxalic acid, formic acid, acetic acid, butyric acid, benzenesulfonic acid, phenolsulfonic acid, p-toluenesulfonic acid, naphthalene-α-sulfonic acid, naphthalene-β-sulfonic acid, or the like; an organic acid ester such as oxalic dimethyl ester, or the like; an acid anhydride such as maleic anhydride, phthalic anhydride, or the like; an ammonium salt such as ammonium chloride, ammonium sulfate, ammonium nitrate, ammonium oxalate, ammonium acetate, ammonium phosphate, ammonium thiocyanate, ammonium imide sulfonate, or the like; an organic halide such as monochloroacetic acid or its sodium salt, α,α′-dichlorohydrin, or the like; a hydrochloride of amines such as triethanolamine hydrochloride, aniline hydrochloride, or the like; a urea adduct such as salicylic acid urea adduct, stearic acid urea adduct, heptanoic acid urea adduct, or the like; an acid substance such as N-trimethyl taurine, zinc chloride, ferric chloride, or the like; ammonia; amines; a hydroxide of an alkaline metal or alkaline earth metal such as sodium hydroxide, potassium hydroxide, barium hydroxide, calcium hydroxide, or the like; an oxide of an alkaline earth metal such as lime, or the like; an alkaline substance like an alkaline metal salt of weak acid such as sodium carbonate, sodium sulfite, sodium acetate, sodium phosphate or the like.

Further, curing agents such as a formaldehyde group compound or alkylol triazone derivative, or the like, may be added to said phenol group resin precondensate (including precocondensation polymer).

Said alkylol triazone derivative is produced by the reaction between the urea group compound, amine group compound, and formaldehyde group compound. Said urea group compound used in the production of said alkylol triazone derivative may be such as urea, thiourea, an alkylurea such as methylurea or the like; an alkylthiourea such as methylthiourea or the like; phenylurea, naphthylurea, halogenated phenylurea, nitrated alkylurea, or the like, or a mixture of two or more kinds of said urea group compound. A particularly desirable urea group compound may be urea or thiourea. As amine group compounds, an aliphatic amine such as methyl amine, ethylamine, propylamine, isopropylamine, butylamine, amylamine or the like, benzylamine, furfuryl amine, ethanol amine, ethylenediamine, hexamethylenediamine hexamethylenetetramine, or the like, as well as ammonia are illustrated, and said amine group compound is used singly or two or more amine group compounds may be used together. The formaldehyde group compound(s) used for the production of said alkylol triazone derivative is (are) the same as the formaldehyde group compound(s) used for the production of said phenol group resin precondensate.

To synthesize said alkylol triazone derivatives, commonly 0.1 to 1.2 moles of said amine group compound(s) and/or ammonia, and 1.5 to 4.0 moles of said formaldehyde group compound are reacted with 1 mole of said urea group compound. In said reaction, the order in which said compounds are added is arbitrary, but preferably, the required amount of formaldehyde group compound is put in a reactor first, after which the required amount of amine group compound(s) and/or ammonia is (are) gradually added to said formaldehyde group compound, the temperature being kept at below 60° C., after which the required amount of said urea group compound(s) is (are) added to the resulting mixture at 80 to 90° C. for 2 to 3 hours, being agitated so as to react together. Usually, 37% by mass of formalin is used as said formaldehyde group compound, but some of said formalin may be replaced with paraformaldehyde, to increase the concentration of the reaction product. Further, in a case where hexamethylene tetramine is used, the solid content of the reaction product obtained is much higher. The reaction between said urea group compound, amine group compound and/or ammonia, and said formaldehyde group compound is commonly performed in a water solution, but said water may be partially or wholly replaced with one or more kinds of alcohol such as methanol, ethanol, isopropanol, n-butanol, ethylene glycol, diethylene glycol, or the like, and one or more kinds of other water soluble organic solvent, such as ketone group solvent like acetone, methylethyl ketone, or the like can also be used as solvents. The amount of said curing agent to be added is, in the case of a formaldehyde group compound, in the range of between 10 and 100 parts by mass, to 100 parts by mass of said phenol group resin precondensate (precocondensation polymer) of the present invention, and in the case of an alkylol triazone derivative, 10 to 500 parts by mass to 100 parts by mass of said phenol group resin precondensate (precocondensation polymer).

[Sulfomethylation and/or Sulfimethylation of Phenol Group Resin]

To improve the stability of said water soluble phenol group resin, said phenol group resin is preferably sulfomethylated and/or sulfimethylated.

### [Sulfomethylation Agent]

The sulfomethylation agents used to improve the stability of the aqueous solution of phenol group resins, include such as water soluble sulfites prepared by the reaction between sulfurous acid, bisulfurous acid, or metabisulfurous acid, and alkaline metals, trimethyl amine, quaternary amine or quaternary ammonium (e.g. benzyltrimethylammonium); and aldehyde additions prepared by the reaction between said water soluble sulfites and aldehydes.

The aldehyde additives are prepared by the addition reaction between said aldehydes and water soluble sulfites as aforementioned, wherein the aldehydes include formaldehyde, acetoaldehyde, propionaldehyde, chloral, furfural, glyoxal, n-butylaldehyde, caproaldehyde, allylaldehyde, benzaldehyde, crotonaldehyde, acrolein, phenyl acetoaldehyde, o-tolualdehyde, salicylaldehyde, or the like. For example, hydroxymethane sulfonate, which is an aldehyde additive, is prepared by the addition reaction between formaldehyde and sulfite.

### [Sulfimethylation Agent]

The sulfimethylation agents used to improve the stability of the aqueous solution of phenol group resins, include alkaline metal sulfoxylates of an aliphatic or aromatic aldehyde such as sodium formaldehyde sulfoxylate (a.k.a. Rongalite), sodium benzaldehyde sulfoxylate, or the like; hydrosulfites (a.k.a. dithionites) of alkaline metal or alkaline earth metal such as sodium hydrosulfite, magnesium hydrosulfite, or the like; and a hydroxyalkanesulfinate such as hydroxymethanesulfinate, or the like.

In a case where said phenol group resin precondensate is sulfomethylated and/or sulfimethylated, said sulfomethylation agent and/or sulfimethylation agent is(are) added to said precondensate at any stage, to sulfomethylate and/or sulfimethylate said phenol group compound and/or said precondensate.

The addition of said sulfomethylation agent and/or sulfimethylation agent may be carried out at any stage, before, during or after the condensation reaction.

The total amount of said sulfomethylation agent and/or sulfimethylation agent to be added is in the range of between 0.001 and 1.5 moles per 1 mole of said phenol group compound. In a case where the total amount of said sulfomethylation agent and/or sulfimethylation agent to be added is less than 0.001 mole per 1 mole of said phenol group compound, the resulting phenol group resin will have an insufficient hydrophilic property, while in a case where the total amount of said sulfomethylation agent and/or sulfimethylation agent to be added is over 1.5 moles per 1 mole of said phenol group compound, the resulting phenol group resin will have insufficient water resistance. To maintain good performance, in such as the curing capability of said produced precondensate, and the properties of the resin after curing, or the like, the total amount of said sulfomethylation agent and/or sulfimethylation agent is preferably set to be in the range of between about 0.01 and 0.8 mole for said phenol group compound.

Said sulfomethylation agent and/or sulfimethylation agent added to said precondensate, to effect the sulfomethylation and/or sulfimethylation of said precondensate, react(s) with the methylol group of said precondensate, and/or the aromatic group of said precondensate, introducing a sulfomethyl group and/or sulfimethyl group to said precondensate.

As aforementioned, an aqueous solution of sulfomethylated and/or sulfimethylated phenol group resin precondensate is stable in a wide range, between acidity(pH1.0), and alkalinity, with said precondensate being curable within any range, acidity, neutrality, or alkalinity. In particular, in a case where said precondensate is cured in an acidic range, the remaining amount of said methylol group decreases, solving the problem of formaldehyde being produced by the decomposition of said cured precondensate.

As said thermosetting resin, said aqueous binder used in said release sheet 1 of the present invention may be used.

To coat or impregnate said thermoplastic resin and/or said thermosetting resin on/in to said porous base material, the same method as in the case where said aqueous binder is coated or impregnated on/in to said base sheet is applied.

The coating or impregnating amount of said thermoplastic resin and/or thermosetting resin on/in to said porous material is commonly set to be in the range of between 10 and 40% by mass of the weight of said porous base material, as a solid.

The resulting porous base material on/in to which said thermoplastic resin and/or thermosetting resin is coated or impregnated is then dried at room temperature or by heating, and in a case where a thermosetting resin is used to coat or impregnate on/in to said porous material, it is preferable that said porous material on/in to which said thermosetting resin is coated or impregnated is heated at a given temperature for a given time, so as to put said thermosetting resin at its B-stage, because the resulting porous base material on/in to which said thermosetting resin at B-stage is contained, can be stored for a long term and retain its moldability.

### [Manufacturing a Molded Article]

To manufacture said molded article 7 of the present invention, first said release sheet(s) 1 is (are) laminated onto one or both sides of said base material 2 as shown in FIG. 3. To laminate said release sheet(s) 1 onto one or both sides of said base material, said release sheet(s) 1 is (are) adhered to said base material 2 using an adhesive, or said release sheet(s) 1 is (are) intertwined with said base material 2 by needle punching.

In a case where said thermoplastic resin and/or thermosetting resin is (are) impregnated into said base material 2, said thermoplastic resin and/or thermosetting resin may be used as an adhesive between said base material, and said release sheet.

So as not to obstruct the air permeability of said release sheet 1, it is preferable to form an adhesive layer having air permeability, and to form said air permeable adhesive layer, a powder type or cobweb type hotmelt adhesive is selected, or in the case of a solution type adhesive or emulsion type adhesive, said adhesive is preferably spray coated, screen printed, or the like, to form dotted air permeable adhesive layer.

Further, in the case of said release sheet 1 onto which said hotmelt adhesive, solution type adhesive, emulsion type adhesive or the like is coated is used, said release sheet(s) 1 is (are) laminated onto one or both sides of said base material 2, and said release sheet(s) 1 is (are) adhered to said base material 2 simultaneously by press molding.

In a case where said base material 2 is porous, and said aqueous binder is impregnated into said porous base material 2 as a thermosetting resin, said base sheet may be laminated onto said base material, and then said aqueous binder is coated or impregnated on/in to the resulting laminated material, and then said laminated material is dried.

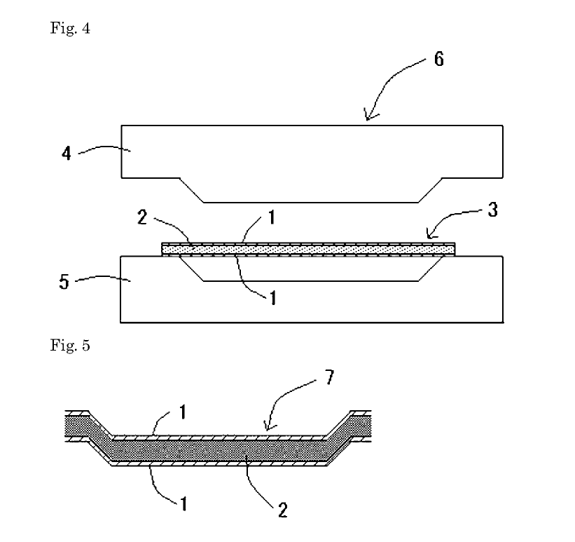

To mold the resulting laminated material 3, commonly a press molding machine 6 consisting of an upper mold part 4 and a lower mold part 5 as shown FIG. 4, is used. Usually a hot pressing is applied to mold said laminated material, but besides said hot pressing, a cold pressing after said laminated material has been heated, or vacuum forming and/or pressure forming may be applied to mold said laminated material.

As aforementioned, a molded article (molded sheet) 7 as shown in FIG. 5 is manufactured, and in an embodiment wherein said release sheets 1,1 are attached to both sides of said base material 2, the releasing property of the resulting molded article 7 is excellent.

In said molding process, in a case where the impregnating material or mixing material is (are) impregnated and/or mixed into said porous base material, said impregnating material and/or mixing material, or the adhesive used to laminate said release sheet 1 and porous base material 2, exude out, but said exuding material is obstructed from reaching the surface of the resulting molded article by said release sheet. Accordingly, the contamination of the surface of said molded article 7 is prevented, so that the good appearance of said molded article is assured.

### EXAMPLES

To describe the present invention further in detail, EXAMPLES are described below, but the scope of the present invention is not limited only by said EXAMPLES.

### Example 1

### Release Sheet

### (1) Porous Sheet (Base Sheet)

A fiber sheet made of a polyester fiber by the spun lace method (unit weight: 40 g/m², thickness: 0.4 mm, airflow resistance: 0.04 kPa·s/m) was used as said porous sheet.

### (2) Aqueous Binder

A mixture of 30 parts by mass of Acrodur 958D (Trade Name BASF Japan Ltd., solid content: 42% by mass) and 70 parts by mass of water was used.

### (3) Preparation of Said Release Sheet

Said aqueous binder was coated and impregnated on/in to said porous sheet with a roll coater in an impregnating amount to be 5% by mass, and then the resulting porous sheet on/in to which said aqueous binder was coated and impregnated was dried at 150° C. for 4 minutes, to prepare a release sheet.

### [Molded Article]

### (1) Base Material

A green felt sheet (thickness: 10 mm, unit weight: 800 g/m²) into which a novolak type phenolic resin powder was mixed, in an amount of 20% by mass for the weight of said green felt sheet, was used.

(2) Manufacture of the molded article

Said release sheets were put onto both sides of said base material, so as to be a green material for molding. Said green material was molded into a predetermined shape by a hot press machine at 200° C. for one minute, after which the resulting molded article was taken out of said hot press machine, to obtain a molded article. As aforementioned, the process wherein said green material was set and molded and taken out, was regarded as a one time molding cycle.

### [Test for Evaluation]

The aforementioned molding cycle was performed once, 5 times, 10 times, 20 times, 50 times, and 100 times under the same conditions, and the sticking of said aqueous binder resin to the hot-press machine, and the appearance of the resulting molded article were visually observed. The results are shown in Table 1.

### Example 2

A molded article was manufactured in the same method as described in EXAMPLE 1, with the exception that a porous sheet (base sheet) as described below was used in EXAMPLE 2.

### (1) Porous Sheet (Base Sheet)

A creped paper made from 100% by mass of pulp fiber (unit weight: 20 g/m², creping degree: 30%, thickness: 0.15 mm, airflow resistance: 0.10 kPa·s/m) was used as the base sheet.

The test results are shown in Table 1.

### Example 3

A molded article was manufactured in the same method as described in EXAMPLE 1, with the exception that a porous sheet (base sheet) as described below was used in EXAMPLE 3.

### (1) Porous Sheet (Base Sheet)

An embossed paper made from 100% by mass of pulp fiber (unit weight: 20 g/m², height of projections: 0.2 mm, number of projections: 120 projections/cm², airflow resistance: 0.10 kPa·s/m) was used as the base sheet.

### [Comparison 1]

A molded article was manufactured in the same method as described in EXAMPLE 1, with the exception that said release sheet was omitted, meaning that only said green felt sheet was used as said base material. Said green felt sheet was repeatedly molded in the same manner as described in EXAMPLE 1. The result is shown in Table 1.

### [Comparison 2]

A molded article was manufactured in the same method as described in EXAMPLE 1, with exception that said aqueous binder was changed to the following binder. The results are shown in Table 1.

### (2) Aqueous Binder

A resol type phenolic resin (solid content: 12.6% by mass, water solution) was used as an aqueous binder.

### [Comparison 3]

A molded article was manufactured in the same method as described in EXAMPLE 1 with the exception that the release film as described below, was used as said release sheet.

### [Release Sheet]

A fluoroglass sheet (glass cloth into which a fluorocarbon resin was impregnated) having a thickness of 0.09 mm was used as said release sheet. The results are shown in Table 1.

TABLE 1

| Shot | | | | | | | |
|---|---|---|---|---|---|---|---|
| number | | Example 1 | Example 2 | Example 3 | Comparison 1 | Comparison2 | Comparison 3 |
| 1 | Resin sticking | ⊚ | ⊚ | ⊚ | ⊚ | ◯ | ⊚ |
| | Moldability | ⊚ | ⊚ | ⊚ | ⊚ | ⊚ | Δ |
| 5 | Resin sticking | ⊚ | ⊚ | ⊚ | ◯ | Δ | ⊚ |
| | Moldability | ⊚ | ⊚ | ⊚ | ⊚ | Δ | Δ |
| 10 | Resin sticking | ⊚ | ⊚ | ⊚ | Δ | ▴ | ⊚ |
| | Moldability | ⊚ | ⊚ | ⊚ | ▴ | ▴ | Δ |
| 20 | Resin sticking | ⊚ | ⊚ | ⊚ | ▴ | X | ⊚ |
| | Moldability | ⊚ | ⊚ | ⊚ | X | X | Δ |
| 50 | Resin sticking | ⊚ | ⊚ | ⊚ | ▴ | | ⊚ |
| | Moldabiliy | ⊚ | ⊚ | ⊚ | ▴ | | Δ |
| 100 | Resin sticking | ⊚ | ⊚ | ⊚ | X | | ⊚ |
| | Moldability | ⊚ | ⊚ | ⊚ | X | | Δ |

### Resin Sticking

The mold surface of the press molding machine was ground with sandpaper adequately enough to remove contaminants, and the release agent was not coated onto the molding surface. Each sample was press molded at 200° C. for one minute, after which the resulting molded article was taken out of the molding machine. Said molding cycle was repeated, and after each cycle, the resin sticking to the mold surface of the press molding machine, and the ease of peeling off of the resulting molded article from said mold surface were checked.

⊚: No resin sticking to the mold surface, the resulting molded article being simply and easily peeled from its mold surface, said molded article having a good appearance.
◯: No resin sticking to the mold surface but a little resistance in peeling the resulting molded article from its mold surface, the resulting molded article, however, having a good appearance.
Δ: Resin sticking was observed at the part where the resulting molded article became thin (high density), with some difficulty peeling the resulting molded article from its mold surface.
▴: Resin sticking was observed as a whole, and when the resulting molded article was peeled from its mold surface, the fibers in said molded article stuck to its mold surface. The resulting molded article, after being taken out of the molding machine, had a distorted shape.
X: The resin and fibers in the resulting molded article stuck to its mold surface, so that the resulting molded article could not be peeled from its mold surface.

### Moldability

⊚: Moldable into a predetermined shape, the resulting molded article having a good appearance.
Δ: Wrinkles formed in the deep drawing part of the resulting molded article.
▴: No shape accuracy in the part where the resulting molded article was thin (high density part).
X: The green material was torn during molding, so that molding could not be performed.

### [Opinion of the Test Results]

Referring to Table 1, the samples of EXAMPLES 1 to 3 relating to the present invention showed no resin sticking to the mold surface, so that the samples of the present invention could be continuously molded without coating release agent onto the mold surface, it being recognized that the samples of the present invention had excellent workability.

On the other hand, in the case of the sample in COMPARISON 1 (without the release sheet), and the sample in COMPARISON 2 (using the thermosetting resin instead of said aqueous binder), in accordance with the number of times the molding cycle was repeated, the resin sticking to the mold surface gradually became noticeable, so that the number of times said molding cycle could be repeated was reduced.

The samples of COMPARISON 3 (a release film was used instead of the resin release sheet of the present invention) showed no sticking of resin to the mold surface, but since said release film was not stretchable into a predetermined shape during molding, the wrinkles which formed in the deep drawing part of said release film created similar wrinkles in said molded article, so the resulting molded article had a problem in its appearance.

### Example 4

### (1) Porous Sheet (Base Sheet)

A fiber sheet, made of a polyester fiber and made by the needle punching method was used. Said fiber sheet had a unit weight of 70 g/m², thickness of 2.0 mm, and airflow resistance of 0.03 kPa·s/m.

### (2) Aqueous Binder

A mixture solution containing 30 parts by mass of Acrodur 958D (Trade Name, BASF Japan Ltd., solid content: 4% by mass), 5 parts by mass of a fluorine group water and oil repellent agent (water solution, solid content: 20% by mass), 3 parts by mass of a carbon black dispersion (solid content: 40% by mass) and 62 parts by mass of water, was used.

### (3) Fire Retardant and Adhesive

A mixture solution containing 20 parts by mass of a polyammonium phosphate powder (particle size: 20 μm) onto which a melamine resin was coated, 15 parts by mass of a polyamidecopolymer (particle size: 15 nm, softening point: 125° C.), and 65 parts by mass of water, was used.

### (4) Preparing a Release Sheet

Said aqueous binder was coated and impregnated on/in to said porous sheet in an impregnating amount to be 35% by mass as a solid with a roll coater. After coating and impregnating said aqueous binder on/in to said porous sheet, said fire retardant and adhesive were spray coated onto the backside of said porous sheet, into which said aqueous binder was impregnated, in an amount to be 15 g/m², after which said porous sheet onto which said fire retardant and adhesive were coated, was then dried at 150° C. for 3 minutes, to obtain a release sheet.

### [Molded Article]

### (1) Base Material

A green glass wool sheet (thickness: 20 mm, unit weight: 700 g/m²) into which a resol type phenolic resin was impregnated in an amount of 20% by mass of said green glass wool sheet was used.

### (2) Manufacture of a Molded Article

Using said release sheet as a surface material, said release sheet was put onto one side of said base material, and then the resulting laminated material was molded into a predetermined shape on a hot plate at 210° C. for 50 seconds, to obtain a molded article.

### [Evaluation]

The resulting molded article had an excellent releasing property from the hot-press molding machine owing to the use of said release sheet as its surface material, and said molded article could be molded with high accuracy, and further the surface of said molded article had a good appearance. Further, regarding said molded article, since it could be released from its mold without using a release agent, it was free from the negative effects of said agent, and the molding cycle exceeded 100 times, making the workability and productivity of said molded article excellent.

Further, on the backside of said molded article, the surface of said glass wool seemed to stick to the mold surface after about 30 times of the molding cycle, however, since said defect originated from the sticking of said glass wool to the mold surface occurred on the backside of said molded article, said defect was not to be the total ruin of said molded article.

Still further, the resulting molded article had an excellent sound absorbing performance, heat insulating property, and flame retardant property, said molded article being useful for a car's cylinder head cover, engine under cover, insulator hood, and the like.

### [Comparison 4]

A molded article was manufactured in the same method as described in EXAMPLE 4, with the exception that said aqueous binder was changed to the following mixture solution.

### (2) Aqueous Binder

Said mixture solution contained 30 parts by mass of a resol type phenolic resin precondensation polymer (solid content: 42% by mass), 5 parts by mass of a fluorine group water and oil repellent agent (water solution, solid content: 20% by mass), 3 parts by mass of a carbon black water dispersion (solid content: 40% by mass), and 62 parts by mass of water.

### [Evaluation]

After 5 repetitions of the molding cycle, the resin contained in said porous sheet (fiber sheet) on the surface material side seemed to stick to the mold surface, and at the 7^{th} repetition of the molding cycle, the fibers in said porous sheet visibly stuck to the mold surface, resulting in an inferior appearance of the surface material of the resulting molded article. Accordingly in the case of said molded article, it was necessary to spray coat a release agent onto the mold surface after every 2 or 3 repetitions of the molding cycle, making the workability of the manufacturing of said molded articles inferior.

### Example 5

### Release Sheet

### (1) Porous Sheet (Base Sheet)

A fiber sheet made of a polyester fiber and made by the needle punching method (unit weight: 120 g/m², thickness: 2.0 mm, airflow resistance: 0.04 kPa·s/m) was used in EXAMPLE 5.

### (2) Aqueous Binder

A mixture solution containing 40 parts by mass of Acrodur (Trade Name, BASF Japan Ltd., solid content: 42% by mass), 5 parts by mass of a fluorine group water and oil repellent agent (water solution, solid content: 20% by mass), 3 parts by mass of a carbon black water dispersion (solid content: 40% by mass), and 52 parts by mass of water was used as an aqueous binder in EXAMPLE 5.

### (3) Adhesive

A mixture solution containing 25 parts by mass of a polyamide copolymer (particle size: 15 μm, softening point: 125° C.) and 75 parts by mass of water was used as an adhesive.

### (4) Preparation of Said Release Sheet

Said aqueous binder was coated and impregnated on/in to said porous sheet in an impregnating amount to be 45% by mass for said porous sheet with a roll coater.

Next, said adhesive was then spray coated onto the backside of said porous sheet, into which said aqueous binder was impregnated, in a coating amount to be 10 g/m² for said porous sheet, after which said porous sheet, into which said aqueous binder was impregnated, and onto the backside of which said adhesive was coated, was then dried at 150° C. for 4 minutes, to obtain a release sheet.

### [Molded Article]

### (1) Base Material

A fiber sheet made of a fiber mixture containing 40 parts by mass of a reclaimed fiber from the felt scrap, 30 parts by mass of a polyester fiber having a low melting point (melting point: 140° C.), 20 parts by mass of a polyester fiber, and 10 parts by mass of a polypropylene fiber (unit weight: 800 g/m², thickness: 20 mm) was used as a base material.

### (2) Manufacturing a Molded Article

Using said release sheet as a surface material, said release sheets as the surface materials were put onto both sides of said base material, and the resulting laminated material, consisting of said base material, and said release sheets on both sides of said base material was heated at 200° C. for 60 seconds, after which said laminated material was immediately cold-pressed, to obtain a molded article having a predetermined shape.

### [Evaluation]

Said molded article could be continuously manufactured without the sticking of the resin in said release sheet to the mold surface, the workability during the manufacturing of said molded article being excellent.

Further, in said molded article, naps on the surface of said fiber sheet formed by the needle punching process were covered with the film of said aqueous binder impregnated into said release sheet, so that the resulting molded article had an excellent smooth surface, and the airflow passing through said molded article was improved, and besides its sound absorbing performance, said molded article had unexpected effect in that said molded article had a water repellent property, so that snow sticking on said molded article was easily removed. Accordingly said molded article is useful for a car's body under cover, fender liner, and pipe wall material for an intake duct.

### [Comparison 5]

A molded article was manufactured in the same method using the same porous sheet (base sheet) as described in EXAMPLE 5 with the exception that said aqueous binder was changed to the following binder.

### [Sheet]

### (1) Aqueous Binder

An aqueous binder made of a mixture solution containing 40 parts by mass of methacylic acid ester-styrene copolymer emulsion (solid content 42% by mass, Tg: 75° C.), 5 parts by mass of a fluorine group water repellent and oil repellent agent (water solution, solid content: 20% by mass), 3 parts by mass of a carbon black water dispersion (solid content: 40% by mass), and 52 parts by mass of water was used as an aqueous binder.

### [Molded Article]

### (2) Manufacturing a Molded Article

Using said sheet as a surface material, said sheets were put onto both sides of said base material, further, a silicon film (thickness: 0.2 mm) was put onto said sheets, after which said base material, both sides of which were covered with said sheets and silicone film, was set onto a hot plate, and then heated at 200° C. for 60 seconds, and immediately cold pressed, to obtain a molded article having a predetermined shape.

### [Evaluation]

As for said molded article, when said base material, on both sides of which said silicon film was set on, was molded by cold pressing, the surface of the deep drawing part of said molded article had wrinkles derived from said silicone film, and as a result, said molded article had a problem in having an inferior appearance.

On the other hand, in a case where said silicone film was removed from said sheets on both sides of said base material before cold press molding, there was a problem in that it took some time to remove said silicone film from said sheets on both sides of said base material.

### Example 6

### Release Sheet

### (1) Porous Sheet (Base Sheet)

A creped paper made from 70 parts by mass of a broad-leaved tree pulp and 30 parts by mass of a conifer wood pulp (unit weight: 30 g/m², creping degree: 35% thickness: 0.15 mm, airflow resistance: 0.42 kPa·s/m) was used in EXAMPLE 6.

### (2) Aqueous Binder

A mixture solution containing 30 parts by mass of Acrodur 958D (Trade Name, BASF Japan Ltd., solid content: 42% by mass) and 70 parts by mass of water was used as an aqueous binder.

### [Molded Article]

### (1) Base Material

A base material was prepared by hot-pressing a web at 160° C. to form a base material having a sheet shape, wherein said web was made by the uniform mixing of a fiber mixture containing 40 parts by mass of a polyester fiber, 40 parts by mass of a kenaf fiber, and 20 parts by mass of a polyester fiber having a low melting point (melting point: 150° C.), with an opening machine. The resulting base material had a thickness of 10 mm, and a unit weight of 400 g/m².

### (2) Manufacturing a Molded Article

A polyester copolymer powder (particle size: 100 μm, melting point: 110° C.) as a hot melt adhesive was scatter coated onto one side of said porous sheet (base sheet) in a coating amount of 15 g/m², and then said porous sheet, onto which said polyester copolymer (hotmelt adhesive) powder was coated, was heated at 130° C., to adhere said hot melt adhesive powder to said porous sheet (base sheet).

At the same time, said base material was put onto said porous sheet (base sheet) so as to attach said base material to the side of said porous sheet onto which said hot melt adhesive powder was coated, after which the resulting laminated material of said base material and said porous sheet (base sheet) was cooled by pressing with a cooling roll so as to adhere said porous sheet (creped paper) to said base material, to obtain a double layered sheet.

Said aqueous binder was spray coated onto the creped paper side of said double layered sheet in an amount to be 7% by mass for said double layered sheet after which said double layered sheet onto which said aqueous binder was coated, was then suction dried by heating at 100° C. for 4 minutes, so as to impregnate said aqueous binder into said creped paper to be a release sheet, so that a green material wherein said release sheet was adhered to said base material was prepared.

Said green material was then heated on a hot plate at 200° C. for 60 seconds, and then immediately cold-pressed, to obtain a molded article having a predetermined shape.

### [Evaluation]

The resulting molded article did not stick onto the mold surface of the press machine during molding, so that said molded article could be continuously manufactured, and had an excellent workability during molding.

The resulting molded article has an excellent sound absorbing performance, so said molded article is useful for car's interiors such as the under side of the carpet, floor mat, room partition silencer, and the like.

### Example 7

### Release Sheet

### (1) Porous Sheet (Base Sheet)

A fiber sheet made of a polyester fiber, and made by the thermal bonding method (unit weight: 20 g/m², thickness: 0.15 mm, airflow resistance: 0.04 kPa·s/m) was used in EXAMPLE 7.

### (2) Aqueous Binder

A mixture solution containing 35 parts by mass of Acrodur 958D (Trade Name, BASE Japan Ltd., solid content: 42% by mass), 15 parts by mass of a methacrylic ester-acrylic ester copolymer emulsion (solid content: 50% by mass, Tg: 45° C.), 5 parts by mass of a fluorine group water and oil repellent agent (water solution: solid content: 20% by mass), and 45 parts by mass of water was used as an aqueous binder.

### (3) Preparing a Release Sheet

Said aqueous binder was coated and impregnated on/in to said porous sheet with a roll coater in an impregnating amount to be 20% by mass for said porous sheet as a solid, and then said porous sheet, into which said aqueous binder was impregnated, was then dried at 140° C. for 4 minutes, to prepare a release sheet.

### [Molded Article]

### (1) Base Material

A electron beam cross-linking type foamed polypropylene sheet (thickness: 1.5 mm) was used as a base material.

### (2) Manufacturing a Molded Article

Said release sheets were put onto the both sides of said base material, after which the resulting laminated material was then put onto a hot plate at 160° C., so as to melt the surface of said base material and adhere said release sheets to said base material.

The resulting laminated material was then vacuum formed into a predetermined shape, to obtain a molded article.

### [Evaluation]

The resulting molded article was easily removed from the mold surface of the hot plate, its surface having a good appearance, excellent abrasion resistance, water repellency, and durability, and further, an excellent sound absorbing performance, so that said molded article is useful for a water shield in the door of a car, and the like.

### POSSIBILITY OF THE INDUSTRIAL USE

Said molded article of the present invention can easily be removed from the mold, so that said molded article has improved producibility, and further, a molded article having an excellent appearance can be manufactured. Since said molded article is exceedingly useful for such as the interior of a car, the present invention can also be used industrially.

1. A release sheet attached to one or both sides of a base material which is to be molded into a predetermined shape, characterized by coating or impregnating an aqueous binder on/in to a porous sheet having an airflow resistance in the range of between 0.01 and 1.2 kPa·s/m, wherein said aqueous binder containing (A) a polymer produced by radical polymerization of an ethylenical unsaturated dicarboxylic anhydride, or an ethylenical unsaturated dicarboxylic acid whose carboxylic acid group can form an acid anhydride group, and (B) an alkanolamine having at least two hydroxyl groups.

2. A release sheet in accordance with claim 1, wherein said porous sheet is a fiber sheet.

3. A release sheet in accordance with claim 1, wherein said porous sheet is a paper.

4. A release sheet in accordance with claim 3, wherein said paper is a stretchable paper which is creped and/or embossed.

5. (canceled)

6. (canceled)
